(19) United States
(12) Patent Application Publication
(10) Pub. No.: US 2007/0013817 A1
(43) Pub. Date: Jan. 18, 2007

(54) Display device and rear projection display device

(76) Inventors: Jing-Lin Zhang, Chu-Nan (TW); Po-Hsuan Huang, Chu-Nan (TW)

Correspondence Address: J.C. Patents, Inc., Suite 250, 4 Venture, Irvine, CA, 92618, US

(21) Appl. No.: 11/454,728

(22) Filed: Jun. 16, 2006

(30) Foreign Application Priority Data
Jul. 12, 2005 (TW) 94211793

(51) Int. Cl. G03B 21/18; H04N 5/74

(52) U.S. Cl. 348/748; 353/57

(57) ABSTRACT

A display device including a housing, a screen, a main board module, and a heat dissipation module is provided. The housing includes an inlet and an outlet. The screen is fixed on the housing. The main board module and the heat dissipation module are disposed inside the housing. The heat dissipation module includes a fan and an air-guiding structure and the fan is configured to provide air flow. The air-guiding structure is arranged near the inlet to form an air-flow channel. The air flow is transmitted through the air-flow channel out of the display device. The main board module is disposed on a way of the air-flow channel. Therefore, the cool air flow volume flowing for cooling the main board module is increased. The efficiency of the heat dissipation module and the reliability of the display device are improved.

### CROSS-REFERENCE TO RELATED APPLICATION

This application claims the priority benefit of Taiwan application serial no. 94211793, filed on Jul. 12, 2005. All disclosure of the Taiwan application is incorporated herein by reference.

### BACKGROUND OF THE INVENTION

1. Field of Invention

The present invention relates to a display device. More particularly, the present invention relates to a rear projection display device.

2. Description of Related Art

With the advantage of large size, the rear projection display device has become popular and received more attention. Please refer to FIG. 1A and FIG. 1B, the conventional rear projection display device 10 includes a housing 11, a screen 12, an optical engine 16 and a main board module 13. The optical engine 16 is disposed in the housing 11, and the screen 12 is fixed on the housing 11. The optical engine 16 projects an image created thereof onto the screen 12, so as to display various still and dynamic images. The main board module 13, disposed within the housing 11, comprises a housing 14 and electronic devices (not shown) within the housing 14. The electronic devices often produce high temperature during operation. Using a digital tuner as an example, the operation temperature can be above 80° C. In order to prevent the electronic device from overheat leading to temporary or permanent breakdown of the conventional rear projection display device 10, a good heat dissipation design is required to ensure normal operation of the conventional rear projection display device 10.

According to the above objective of heat dissipation, the conventional rear projection display device 10 further includes a plurality of ventilators 15, which are disposed at the housing 14 of the main board module 13, and an inlet 17 and an outlet 18 are disposed on the housing 11 of the conventional rear projection display device 10, wherein a fan 19 is configured near the outlet 18 to provide a cool air flow to decrease the temperature inside the conventional rear projection display device 10.

However, as there is no structure to guide the cool air flow provided by the fan 19, most of the cool air flow will not pass through the inside of the main board module 13, so that the cooling effect for the electronic devices inside the main board module is bad.

### SUMMARY OF THE INVENTION

Accordingly, the present invention is directed to a display device having a heat dissipation module, wherein the heat dissipation module comprises an air-guiding structure, so that the efficiency of the heat dissipation module is improved and the breakdown of the electronic device due to overheating can be avoided.

Another objective of the present invention is to provide a rear projection display device having a heat dissipation module, wherein the heat dissipation module comprises an air-guiding structure, so that the efficiency of the heat dissipation module is improved and the breakdown of the electronic device of the rear projection display device due to overheating can be avoided. Accordingly, the life span of the rear projection display device is improved.

According to the above objectives, a display device including a housing, a screen, a main board module and a heat dissipation module is provided. The housing has an inlet and an outlet. The screen is fixed on the housing. The main board module is disposed inside the housing. The heat dissipation module is disposed inside the housing, and the heat dissipation module comprises a fan and an air-guiding structure, wherein the fan is suitable to provide an air flow. The air-guiding structure is arranged near the inlet to form an air-flow channel. The air flow is transmitted through the air-flow channel out of the display device. The main board module is disposed on a way of the air-flow channel.

In the display device of the present invention, as the heat dissipation module comprises an air-guiding structure and the housing of the main board module comprises a plurality of ventilators, the cooling air flow volume flowing through the main board module is increased, so that the efficiency of the heat dissipation module and the reliability of the display device are improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic front view of a conventional rear projection display device.

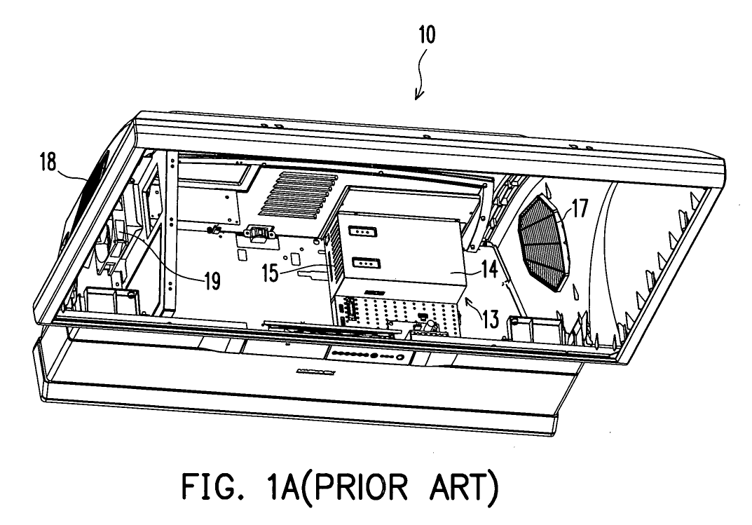

FIG. 1B is a schematic rear view of a conventional rear projection display device.

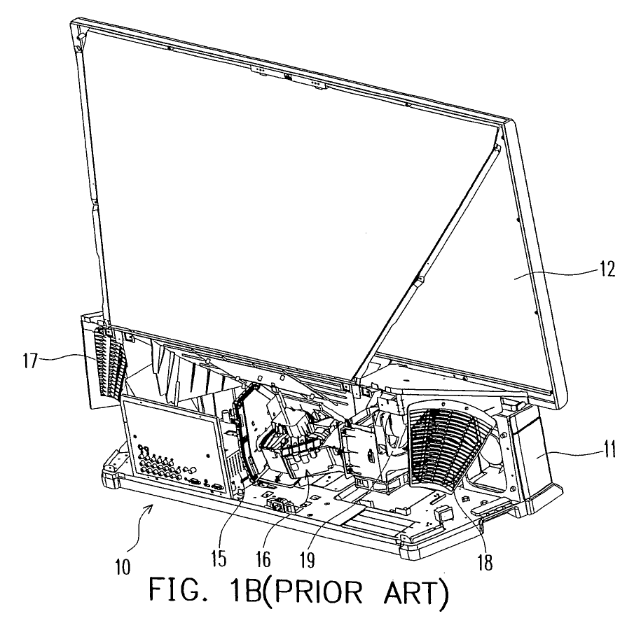

FIG. 2 is a schematic front view of a rear projection display device of the present invention.

FIG. 3 is a schematic explosive rear view of a rear projection display device of the present invention.

FIG. 4 is a schematic side view of a rear projection display device of the present invention.

### DESCRIPTION OF THE EMBODIMENTS

The display device of the present invention will now be described using the rear projection display device as example, but the present invention is not limited thereto.

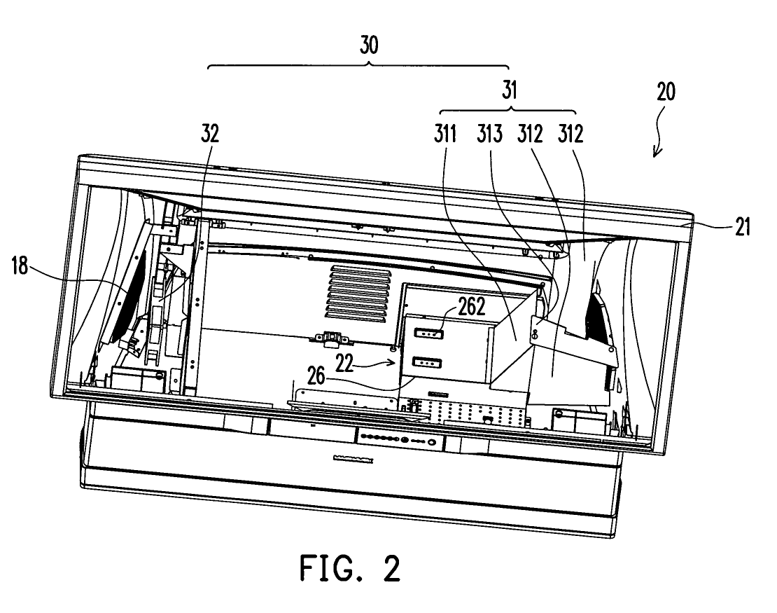

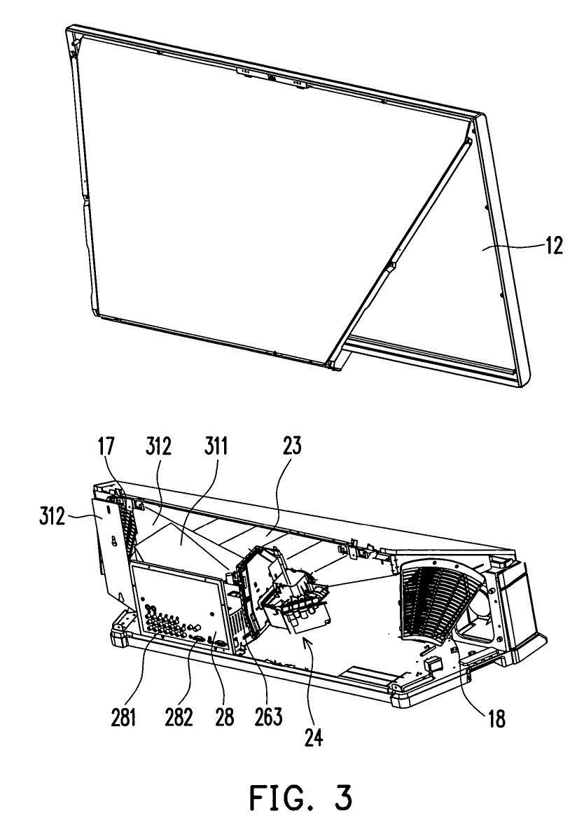

Referring to FIG. 2 and FIG. 3 simultaneously, the rear projection display device 20 includes a housing 21, a screen 12, an optical engine 24, a main board module 22 and a heat dissipation module 30. The housing 21 comprises an inlet 17 and an outlet 18, and a partition 23 is disposed inside the housing 21. The optical engine 24, the main board module 22 and the heat dissipation module 30 are disposed inside the housing 21, and the main board module 22 and the heat dissipation module 30 are disposed under the partition 23. Moreover, the screen 12 is fixed on the housing 21 above the partition 23. It is known for those skilled in the art that the optical engine 24 is used to produce optical images, and project the optical images onto the screen 12 to display various still and dynamic images. Note that the partition 23 has shading function, so that the optical images created by the optical engine 24 are not transmitted below the partition 23. A transmission path of the optical images is above the partition. Accordingly, the rear projection display device 20 has higher optical efficiency.

Refer to FIG. 2 and FIG. 3, the main board module 22 comprises, for example, a housing 26 and an electronic device (not shown) inside the housing 26, and an input/output panel 28 of the housing 21 comprises a plurality of terminals 281 and connection ports 282. The terminals 281 and the connection ports 282 are electrically connected to the main board module 22, so that external signals can be input into the main board module 22 via the terminals 281 or connection ports 282. Then, after the external signals are calculated and processed by the electronic device inside the main board module 22, the main board module 22 obtains signals to control the optical engine 24. Thus, the optical images can be created by the optical engine 24 and projected onto the screen 12.

As the main board module 22 comprises many electronic devices (i.e., digital tuner), and these electronic devices often produce a great deal of heat, the heat is dissipated by a better heat dissipation structure to avoid a breakdown of the electronic device resulting from high temperature.

Referring to FIG. 2 and FIG. 3 again, the heat dissipation module 30 includes an air-guiding structure 31 and a fan 32. In the present invention, the fan 32 is, for example, disposed near the outlet 18 to provide a cool air flow. Of course, in other embodiments of the present invention, the fan 32 can also be disposed near the inlet 17, and the present invention is not limited thereto.

Moreover, the air-guiding structure 31 is, for example, disposed near the inlet 17 to form an air-flow channel (not shown), so that the cool air flow from the fan can flow through the air-flow channel to the outlet 18. Note that the main board module 22 is on a way of the air-flow channel. That is, after the cool air flow enters the housing 21, it flows through the main board module 22 and flow out of the housing 21 via the outlet 18, so that the heat of the main board module 22 is dissipated.

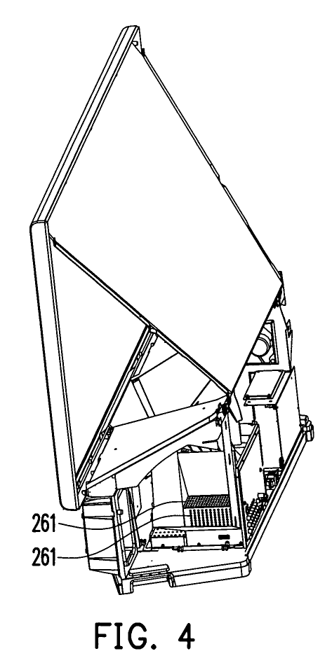

In detail, referring to FIG. 2, FIG. 3 and FIG. 4 simultaneously, the housing 26 of the main board module 22 has a plurality of ventilators 261, 262 and 263, The cool air flow enters the main board module 22 via the ventilator 261 to cool down the electronic devices inside the main board module 22, then flows out of the main board module 22 via the ventilator 263, so as to achieve an objective of heat dissipation. Note that the top of the housing 26 comprises a plurality of the ventilators 262 to improve the efficiency of heat dissipation.

Referring to FIG. 2 and FIG. 3 again, the air-flow structure 31 comprises, for example, a rear baffle-plate 311, a side baffle-plate 312 and a top baffle-plate 313. Wherein, the rear baffle-plate 311 is disposed on the main board module 22, and the rear baffle-plate 311 is, for example, a cuneal baffle-plate. The side baffle-plate 312 is disposed on the housing 21, and connected to the rear baffle-plate 311. The top baffle-plate 313 is disposed on the rear baffle-plate 311 and the side baffle-plate 312. Accordingly, a space is formed between the inlet 17 and the main board module 22 by the rear baffle-plate 311 and the side baffle-plate 312. In the present embodiment, the top baffle-plate 313, for example, is integrated with the partition 23. Therefore, the partition 23 prevents the cool air-flow from leaking above the partition 23 to form a turbulent flow, so that the heat dissipation efficiency of the cool air-flow for the main board module 23 under the partition 23 is improved.

Note that, an objective of the rear baffle-plate 311, the side baffle-plate 312 and the top baffle-plate 313 is to concentrate the cool air-flow to pass through the main board module 22. In the present invention, the top of the inlet 17 is, for example, higher than the height of the main board module 22. If there is no appropriate guiding structure design, there would be much cool air-flow passing above the main board module 22, wherein the cool air-flow can only dissipate the heat of the housing 26 of the main board module 22, but not directly cool down the electronic devices inside the main board module 22. Therefore, in the present invention, the cool air-flow passing above the main board module 22 is concentrated downward by the rear baffle-plate 311 and the side baffle-plate 312, and then flows to the ventilator 261 of the housing 26. The volume of the cool air-flow entering the main board module 22 is increased by the ventilator 261, so as to achieve the objective of improving the heat dissipation efficiency.

Note that, considering the design and manufacturing process, those skilled in the art can learn that the display devices with different specification may have main board modules 22 with different size, and the present invention can design different air-flow structures 31 depending on the size of the main board module 22. Moreover, the air-flow structure 31 is not limited to including the rear baffle-plate 311, the side baffle-plate 31 and the top baffle-plate 313 of the above embodiment. The air-flow structure 31 can also be made integrally or comprise more elements. And, the shape of the air-flow structure is not limited as long as it can guide the cool air flow to pass through the inside of the main board module 22.

In addition, the heat dissipation design of the present invention is not limited to the application of the rear projection display device. It can also be applied in other display devices.

In summary, the heat dissipation module of the present invention comprises an air-guiding structure guiding the cool air flow to the inside of the main board module to increase the volume of cool air flow entering the main board module, then further improve the heat dissipation efficiency and decrease the temperature of the electronic element inside the main board module. Therefore, the reliability of the display device is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display device, comprising:
a housing, having an inlet and an outlet;
a screen, fixed on the housing;
a main board module, disposed inside the housing; and
a heat dissipation module, disposed inside the housing, comprising:
a fan, suitable for providing an air flow; and
an air-guiding structure, arranged near the inlet to form an air-flow channel,
wherein the air flow flows to the outlet through the air-flow channel and the main board module is disposed on away of the air-flow channel.

2. The display device as claimed in claim 1, wherein the main board module further comprises a housing.

3. The display device as claimed in claim 2, wherein the housing of the main board module has a plurality of ventilators to make the air flow pass through the inside of the housing of the main board module.

4. The display device as claimed in claim 1, wherein the air-flow structure comprises:
a rear baffle-plate, disposed on the main board module; and
a side baffle-plate, disposed on the housing and connected to the rear baffle-plate.

5. The display device as claimed in claim 4, wherein the air-flow structure comprises a top baffle-plate, disposed on the rear baffle-plate and the side baffle-plate to form a space between the inlet and the main board module.

6. The display device as claimed in claim 4, wherein the rear baffle-plate is a cuneal baffle-plate.

7. The display device as claimed in claim 1, wherein the fan is disposed near the inlet or the outlet.

8. The display device as claimed in claim 1, wherein the main board module further comprises a tuner.

9. A rear projection display device, comprising:
a housing, having an inlet and an outlet;
a partition disposed inside the housing;
a screen, fixed on the housing and disposed above the partition;
an optical engine, disposed inside the housing and adapted to produce optical images and project the optical images onto the screen, wherein a transmission path of the optical images is above the partition;
a main board module, disposed inside the housing and under the partition; and
a heat dissipation module, disposed inside the housing and under the partition; the
heat dissipation module comprising:
a fan, adapted for providing an air flow; and
an air-guiding structure, arranged near the inlet to form an air-flow channel,
wherein the air flow flows to the outlet through the air-flow channel and the main board module is on a way of the air-flow channel.

10. The rear projection display device as claimed in claim 9, wherein the main board module further comprises a housing.

11. The rear projection display device as claimed in claim 10, wherein the housing of the main board module has a plurality of ventilators to make the air flow pass through the inside of the housing of the main board module.

12. The rear projection display device as claimed in claim 9, wherein the air-flow structure comprises:
a rear baffle-plate, disposed on the main board module; and
a side baffle-plate, disposed on the housing and connected to the rear baffle-plate.

13. The rear projection display device as claimed in claim 12, wherein the air-flow structure further comprises a top baffle-plate disposed on the rear baffle-plate and the side baffle-plate to form a space between the inlet and the main board module.

14. The rear projection display device as claimed in claim 13, wherein the top baffle-plate and the partition are integrally formed.

15. The rear projection display device as claimed in claim 12, wherein the rear baffle-plate is a cuneal baffle-plate.

16. The rear projection display device as claimed in claim 9, wherein the fan is disposed near the inlet or the outlet.

17. The rear projection display device as claimed in claim 9, wherein the main board module further comprises a tuner.
